(19) United States
(12) Patent Application Publication
(10) Pub. No.: US 2009/0292500 A1
(43) Pub. Date: Nov. 26, 2009

(54) USER INTERFACE FOR ESTABLISHING SYNCHRONOUS SAMPLING CHARACTERISTICS FROM ASYNCHRONOUS DATA ACQUISITIONS

(75) Inventors: Leo David FRISHBERG, Portland, OR (US); Timothy E. BIEBER, Portland, OR (US)

Correspondence Address: THOMAS F. LENIHAN;TEKTRONIX, INC., 14150 S. W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 12/126,671

(22) Filed: May 23, 2008

(51) Int. Cl. G06F 15/00

(52) U.S. Cl. 702/127

(57) ABSTRACT

A test and measurement instrument and method of configuring the same is disclosed. The method includes presenting acquired data, where the acquired data includes a plurality of signals; receiving a user input; and defining a sampling characteristic of the test and measurement instrument in response to the user input manipulating the presented acquired data.

### FIELD OF THE INVENTION

This disclosure relates to test and measurement instruments, in particular to test and measurement instruments for synchronous acquisition.

### BACKGROUND OF THE INVENTION

Logic Analyzers (LAs) are a class of test and measurement instruments that provide visibility into certain behaviors of digital circuits. LAs can acquire signals in two different ways, asynchronously and synchronously. Asynchronous acquisition is in relation to a clock independent of a System Under Test (SUT). Synchronous acquisition is in relation to the clock on a SUT. Asynchronous acquisitions can be taken to help analyze errors associated with the timing of signals within the SUT. Synchronous acquisitions can be used to analyze the logical functionality of the circuit. That is, synchronous acquisitions help determine whether the state of the SUT at each clock tick is as designed.

Synchronous acquisitions depend on the user defining the clocking and sampling characteristics of their SUT within the context of the LA so that the LA can accurately sample the signals in relation to the clock on the SUT. These sampling characteristics include characteristics such as: the signal or signals used to define the clock or combined clock, on which edge or edges of the clock data is valid, and the time envelope around the clock edges in which the data is valid such as setup and hold times.

Conventionally, a user identifies the sampling characteristics outside of the context of the acquired input signals. For example, a user may identify a name of a clock in a drop down box and identify a rising or falling edge for the clock through a button. Additional qualifying signals such as a strobe can be similarly identified. Similarly, setup and hold times are defined outside of the context of presented data. However, such inputs of sampling characteristics are isolated from any presented input signals.

### SUMMARY OF THE INVENTION

An embodiment includes a test and measurement instrument including an acquisition system configured to acquire input signals; a processor coupled to the acquisition system; and a user interface coupled to the processor, the user interface configured to receive user input. The processor is configured to present the input signals through the user interface; and define a sampling characteristic of the test and measurement instrument in response to the user input manipulating the presented input signals.

Another embodiment includes a method of configuring a test and measurement instrument including presenting acquired data, the acquired data including signals; receiving a user input; and defining a sampling characteristic of the test and measurement instrument in response to the user input manipulating the presented acquired data.

Another embodiment includes a test and measurement instrument including means for asynchronously acquiring input signals; means for presenting the input signals and distinguishing at least one of the input signals based on a classification of the input signal; and means for receiving user input confirming the classification of the input signal.

### BRIEF DESCRIPTION OF THE DRAWING

FIG. 1 is a block diagram illustrating a test and measurement instrument with a user interface for defining sampling characteristic according to an embodiment.

FIG. 2 is a block diagram illustrating an example of a user interface for defining sampling characteristics through a user interface according to an embodiment.

FIG. 3 is a block diagram illustrating an example of a user interface distinguishing a classification of one or more signals according to an embodiment.

FIG. 4 is a block diagram illustrating an example of confirmation of the classification of the signal of FIG. 3.

FIG. 5 is a block diagram illustrating an example of adjusting classifications of signals through a user interface according to an embodiment.

FIG. 6 is a block diagram illustrating an example of a user interface distinguishing classifications of multiple signals according to an embodiment.

FIG. 7 is a block diagram illustrating an example of a user interface presenting a combined clock according to an embodiment.

FIG. 8 is a block diagram illustrating an example of a user interface annotating a setup and hold time according to an embodiment.

FIG. 9 is a block diagram illustrating an example of applying a setup and hold time to other signals through a user interface according to an embodiment.

FIGS. 10 and 11 are block diagrams illustrating an example of a user interface presenting a transition in a signal according to an embodiment.

FIG. 12 is a block diagram illustrating an example of a user interface annotating a setup and hold time according to another embodiment.

### DETAILED DESCRIPTION OF THE EMBODIMENTS

Embodiments include test and measurement instruments and techniques for configuring test and measurement instruments within the context of acquired input signals. Designers of digital circuits do not visualize drop-down boxes and buttons when designing digital circuits. In contrast, the designers visualize timing diagrams of clocks, strobes, data, or other signals. By allowing a designer to configure a test and measurement instrument as if they were designing a digital circuit, that is, by manipulating relationships of signals through a presentation of the signals, the configuration is more intuitive and thus, easier to use.

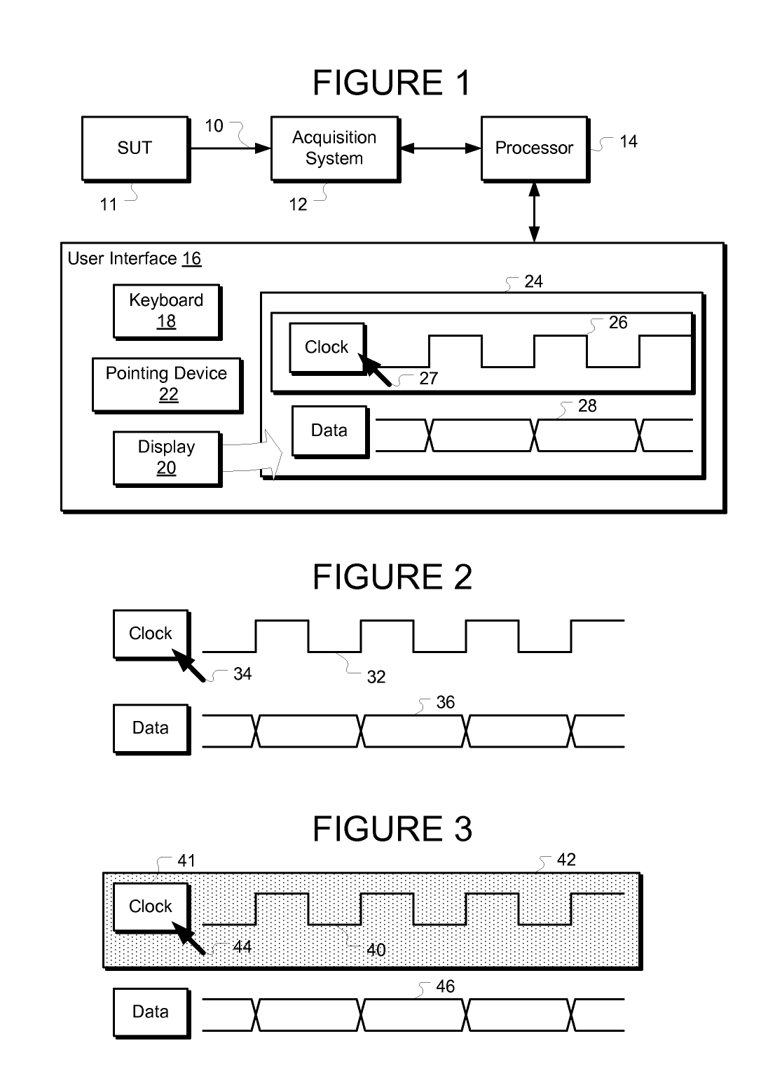

FIG. 1 is a block diagram illustrating a test and measurement instrument with a user interface for defining sampling characteristic according to an embodiment. In this embodiment, the test and measurement instrument includes an acquisition system 12, a processor 14, and a user interface 16.

The acquisition system 12 is configured to acquire input signals 10 from a SUT 11. In an embodiment, the acquisition system 12 can acquire input signals 10 in real time. For example, the acquisition system 12 can be a probe that records a voltage over time at a probe location. The acquisition system 12 can include any number of such probes to acquire multiple signals simultaneously.

In another embodiment, the input signal 10 can be data that was previously stored on a storage device. For example, a software application running on a processor can read the input signal 10 data from a file on the storage device. An acquisition system 12 can include any combination of such real-time and delayed or offline processing.

The acquisition system 12 can acquire input signals asynchronously. As used herein, asynchronously means using a clock signal independent of any signal on the SUT 11. For example, the test and measurement instrument can have an internally generated clock signal that is used for acquiring the input signals 10.

In an embodiment, the acquisition system 12 can acquire multiple samples over a single clock cycle of the input signals 10. As a result, the acquisition system 12 can acquire a representation of the input signals 10 that not only includes state information, but also includes timing information. As a result, such timing information can be subsequently used in establishing sampling characteristics for the test and measurement instrument as described below.

The test and measurement system can be capable of both asynchronous and synchronous acquisition. For example, the acquisition system 12 can be configurable to synchronously acquire input signals 10. That is, the acquisition system 12 can be configured to sample the input signals 10 based on a clock signal that is related to a signal on the SUT 11. Although synchronous acquisition can mean using an input signal 10 as a clock signal for sampling, synchronous acquisition can also mean using a clock signal that is synchronized to an input signal 10 but not identical to the input signal 10.

The processor 14 is coupled to the acquisition system 12. The processor 14 can be a variety of devices. Such devices include general purpose processors, application specific integrated circuits, programmable logic devices, or the like. In addition, the processor 14 may be any combination of such devices.

The user interface 16 encompasses the devices, apparatuses, systems, or the like that handle interactions between the test and measurement instrument and the user. Accordingly, the user interface 16 can be any variety of interfaces. The user interface 16 can include input devices such as knobs, dials, sliders, pointing devices, keyboards, keypad, touch screens, or the like. Keyboard 18 and pointing device 22 are illustrated for example. The user interface 16 can also include output devices such as displays, monitors, speakers, mechanical actuators, or the like. The display 20 is an example of such an output device. Furthermore, such input and output devices can, but need not exclusively be for input or output. For example, the display 20 can be a touch screen operable as both an input and output device. In another example, a network interface can both receive and transmit inputs and outputs from a user.

A user input as used in this discussion is any kind of input received through the user interface 16. For example, interaction with menus, palettes, modal cursors, tools or the like can be a user input. Using the examples in FIG. 1, a user can type on a keyboard 18, move a cursor through the pointing device 22, or the like. As described above, the display 20 can be a touch screen through which user input can be received. Any such communication from a user to the test and measurement instrument can be a user input.

Arrow 27 represents an example of a user input. The arrow 27 can be a cursor that is responsive to the pointing device 22. However, arrows will be used in subsequent descriptions to represent a generic user input. That is, the arrow can also represent any kind of user input different from an input through the pointing device 22.

In an embodiment, processor 14 is configured to present the data view 24 through the user interface 16. In this example, the data view 24 is presented through the display 20. Data view 24 is an example of a presentation of acquired input signals 10 on the display 20. The data view includes a clock signal 26 and a data signal 28. The data view 24 can be a view that is similar in appearance to a timing diagram. As will be described in further detail below, sampling characteristics can be defined in response to a user's manipulation of the input signals such as the clock signal 26 and the data signal 28 presented in the user interface 16.

An embodiment can include means for asynchronously acquiring input signals. The means for asynchronously acquiring input signals can include an acquisition system 12, probes, files, storage devices, and the like as described above. The processor 14 or other processors can be part of the means for asynchronously acquiring input signals. For example, the processor 14 can process data representing the input signals 10 from the acquisition system 12.

FIG. 2 is a block diagram illustrating an example of defining sampling characteristics through a user interface according to an embodiment. In an embodiment, acquired data is presented in the data view. The acquired data includes multiple signals. In this example a clock signal 32 and a data signal 36 are presented. As described above, these signals could have been acquired asynchronously. That is, the signals were not sampled or acquired using a clock signal from a SUT. Due to the asynchronous acquisition, in particular, an asynchronous acquisition that sampled at a sampling rate higher than a frequency of an input signal 10, timing information can be presented in addition to digital signal levels such as a 0 or 1. For example, the sampling rate of the acquisition system 12 can be higher than the frequency of the clock signal 32. As a result, multiple samples of the clock signal 32 can be acquired during one period of the clock signal 32. In particular, multiple samples around a transition of the clock signal 32 can be acquired. From the timing information associated with those samples, timing information for the transition of the clock signal 32 can be obtained.

User input 34 is represented by an arrow. The user input 34 manipulates the presented acquired data. In this example, the user input 34 is selecting clock signal 32. Accordingly, sampling characteristics of the test and measurement instrument can be defined in response to the user input 34.

In this example, the selection by the user input 34 can indicate that the clock signal 32 is to be used as the clock for a synchronous acquisition. Accordingly, operating conditions for the acquisition system 12 or other portions of the test and measurement instrument can be established in response to the user input 34. As a result, the user has been presented with acquired input signals and selected a signal from that data to set-up the test and measurement instrument. All of this selection was within the context of the input signals. The user was not required to provide input to another screen, dialog box, or the like where the acquired input signal is only referenced by name or other abstraction. Thus, the user could focus on the representation of an input signal, rather than on what the signal is named.

FIG. 3 is a block diagram illustrating an example of a user interface distinguishing a classification of one or more signals according to an embodiment. A test and measurement instrument can be capable of classifying signals. For example, a signal may be classified as a clock, a strobe, data, a combined clock, or the like. In another example, a user can classify a particular signal. Regardless of how classified, the classification of the signal can be used in the creation of sampling characteristics for the test and measurement instrument. Moreover, any number of signals can be classified with a variety of classifications.

In this embodiment, the test and measurement unit has classified the clock signal 40 as a clock signal. In this example, the clock signal 40 is distinguished by the placement of the clock signal 40 in a clock definition region 42. The clock definition region 42 is a portion of the data view that can be used in defining a clock for a subsequent acquisition. As a result, the user can see that the clock signal 40 has been classified as a clock. In this example, the distinguishing feature is a change in placement of the clock signal 40. Although the clock signal 40 is illustrated above the data signal 46 and in the clock definition region 42, if the clock signal 40 was not distinguished, it may have been presented below data signal 46, off the data view, outside of the clock definition region 42, or the like. By distinguishing the clock signal 40, as will be described below, the user can now manipulate the clock signal 40, or other signals in relation to the clock signal 40 to configure the test and measurement instrument.

Although a clock definition region 42 has been used as an example of distinguishing a signal, any change can be used to distinguish. For example, color, line weight, line style, or the like of the presentation of the signal can be changed to distinguish it from other signals. In another example, a label 41 for the clock signal 40 can be similarly changed in color, line weight, line style, or the like. In another example, the position of the clock signal 40 can be changed without placing the clock signal 40 within a particular region such as the clock definition region 42. In another example, the signal can be highlighted. Any change can be used to distinguish a signal from among other signals.

An embodiment can include means for presenting the input signals and distinguishing at least one of the input signals based on a classification of the input signal. Such means can include the processor 14 and user interface 16 as described herein. For example, the processor 14 can receive, generate, or otherwise obtain the classification of the input signal. The processor 14 can control the display 20 of the user interface 16 to highlight the associated input signal as described above to distinguish the input signal.

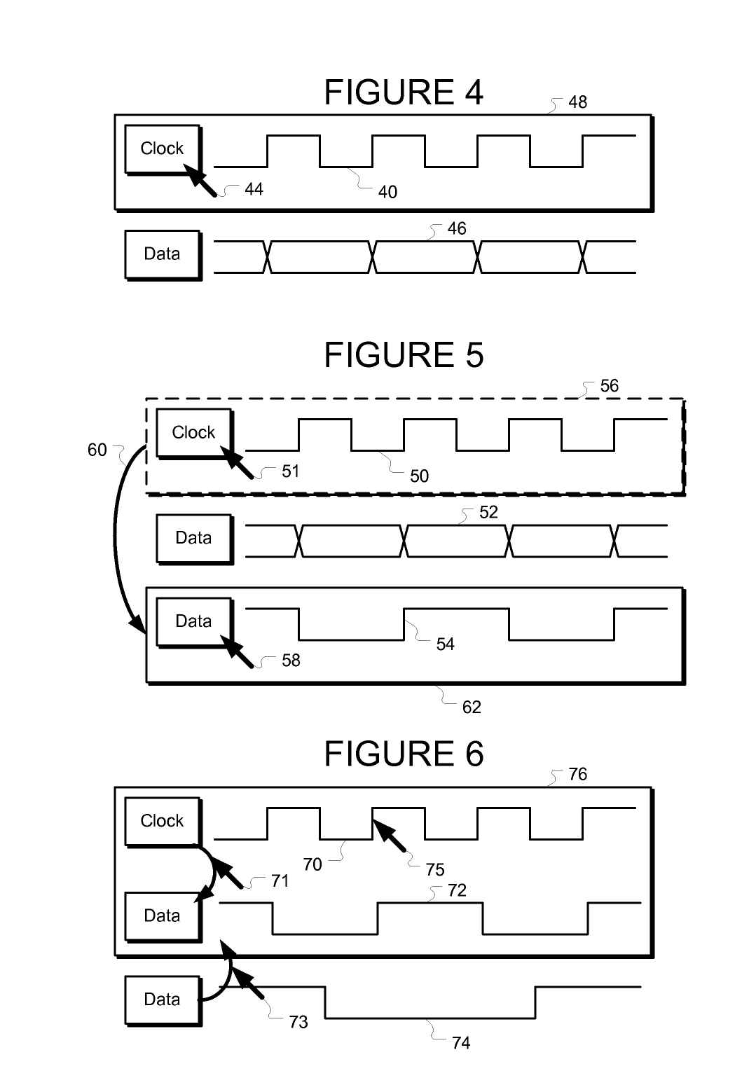

FIG. 4 is a block diagram illustrating an example of a user interface confirmation of the classification of the signal of FIG. 3. Once a signal is distinguished based on a classification, that classification can be confirmed through a user input. For example, the classification of the signal as a clock, strobe, data, or the like can be confirmed by a user input 44 interacting with the presented signal.

The classified signal can be further distinguished to indicate the confirmation. For example, a clock icon can indicate that a presented clock signal is confirmed as a clock signal. The clock signal can be moved to another location on the user interface 16. Any type of change that can be used to initially distinguish a signal, as described above, can also be used to further distinguish the signal. Moreover, changes that are different from changes used to distinguish the signal as being classified can be made to further distinguish the signal as having a confirmed classification.

An embodiment includes means for receiving user input confirming the classification of the input signal. The means for receiving user input confirming the classification of the input signal can include the processor 14 and user interface 16 as described above with reference to FIG. 1. For example, referring to FIG. 1, an input signal 10 that is presented through the data view 24 can be distinguished from other input signals 10 that are also presented through the data view 24. A user can select the distinguished signal through the user interface 16. For example, the user can use the pointing device 22 to select the distinguished signal by manipulating a tool represented by the arrow 27. In this case, the arrow 27 can represent a tool indicating a confirmation of the classification.

An embodiment includes means for establishing operating conditions for the acquisition system in response to the confirmed classification. The processor 14 is an example of such means. For example, in a logic analyzer, the processor 14 can aggregate the user inputs, the state of the display 24, and the like into the sampling characteristics for control of a subsequent synchronous acquisition. The processor 14 can control such acquisition, transfer the sampling characteristics to other systems for control, or the like.

Although FIGS. 3 and 4 illustrate the distinguishing and confirmation of a classification of a single signal, multiple signals can be distinguished and confirmed together. For example, multiple clock signals can be presented in the clock definition region 42 of FIG. 3. Referring to FIG. 4, a user input similar to the user input 44 can be used to confirm the classification of all signals within the clock definition region 48. Moreover, the distinguishing and confirming of the classification of multiple signals is not limited to one type or one class of signals. For example, a clock signal, a strobe, and a data signal can all be distinguished such as by placement in the clock definition region 42 of FIG. 3. Then the classifications can be confirmed individually or in combination as described with reference to FIG. 4.

FIG. 5 is a block diagram illustrating an example of adjusting classifications of signals through a user interface according to an embodiment. Even though some signals may have been classified, the classification could be incorrect. In addition, other signals may not have been classified. Regardless, the classification presented by the user interface may not be what the user desired. Accordingly, the classifications of the signals can be adjusted.

In a first example, the test and measurement instrument classified signal 50 as a clock signal. However, that classification can be incorrect, not desired by a user, or the like. Accordingly, a user can provide the user input 51 to change the classification of the signal 50. For example, the classification can be changed to a different classification, the classification can be eliminated, or the like.

In another example, signal 54 may not have been classified. User input represented by arrow 58 can represent a variety of changes to the classification of the signal 54. For example, the classification that was presented for signal 50 can be moved, copied, or otherwise used to change the classification of signal 54. Arrow 60 represents the change of the classification as a clock signal from the signal 60 to the signal 54. Accordingly, signal 54 is now classified as a clock signal and distinguished by region 62.

In another embodiment, a user input can indicate that the test and measurement instrument should stop classifying signals. For example, a user may find that the test and measurement instrument is habitually incorrectly classifying signals, not classifying other signals, or the like. As a result, the user can disable the classification of the signals. However, a user may still classify signals manually.

FIG. 6 is a block diagram illustrating an example of a user interface distinguishing classifications of multiple signals according to an embodiment. A single clock has been used as an example of a signal for sampling during a synchronous acquisition. However, multiple signals can be used to define sampling characteristics. For example, a SUT can rely on several signals to define its clocking structure, not just a single clock signal. In this embodiment region 76 is a clock definition region. Similar to above, the signals that form a clocking definition of sampling characteristics for the SUT can be defined by user input manipulating the presented signals, for example, by moving signals to the clock definition region 76.

Assume that the clock signal 70 and the data signal 72 have both been confirmed or selected as clock definition signals. A user can combine the signals together to form the sampling characteristics. User input 71 can be a tool corresponding to a logical AND function. Accordingly, through the user input 71, the user can indicate that the clock signal 70 and the data signal 72 should be combined in a logical AND operation to form a combined clock. As used herein, a combined clock is a clock that can be used for sampling that is derived from the combination of other signals. Using the above example, the combined clock is the clock signal 70 logically AND'ed with the data signal 72.

In another example, a user input 75 can indicate a rising edge of the clock signal 70. In response, sampling characteristics can be created to use the rising edge of the clock signal 70. In addition, the edge could be highlighted, changed in color, or otherwise distinguished to indicate that the edge will be so used.

In another example, an additional signal may be needed for the sampling characteristics. Accordingly, a user input 73 can indicate that another data signal 74 is to be added to the sampling characteristics. The data signal 74 can then be combined with the other signals in response to user input. The user input 73 may have an additional operation associated with it. For example, the user input 73 can be a tool corresponding to a logical AND operation similar to that of user input 71 as described above. Accordingly, not only can the user input 73 indicate that data signal 74 is to be part of the sampling characteristics, but it can also indicate how it is to be combined with other signals.

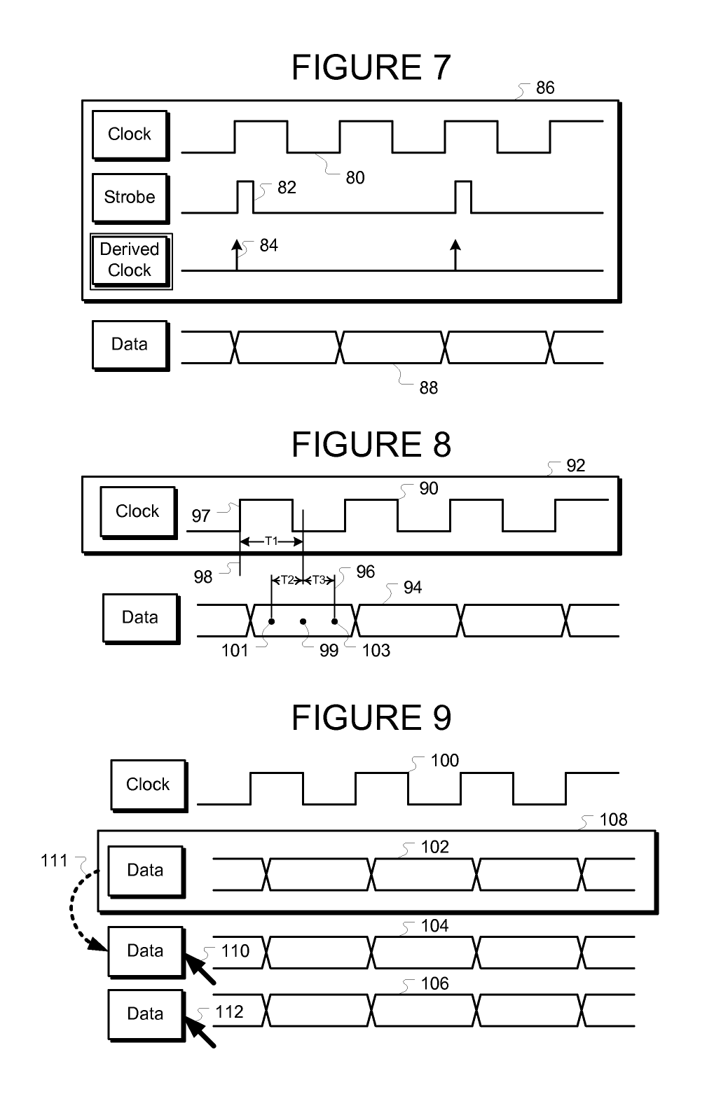

FIG. 7 is a block diagram illustrating an example of a user interface presenting a combined clock according to an embodiment. In this example, region 86 is a clock definition region 86. Clock signal 80 and strobe signal 82 have been added. The relationship between the clock signal and the strobe signal 80 have been defined. The resulting clock definition is illustrated as derived clock signal 84. Thus, a user can see the results of the combination of signals into a clock definition.

Moreover, the derived clock signal 84 can be further used in the user interface as any other signal in the clock definition region. That is, the derived clock signal 84 can be further combined with other signals, used to establish other sampling characteristics, or the like. As the derived clock signal 84 is not an actual signal from the SUT, but rather a composite created from those signals, the derived clock signal 84 can be distinguished from other signals to indicate its derived status. Any variety of different ways as described above for distinguishing signals can be used to distinguish the derived clock signal 84. In the example of FIG. 7, an additional outline has been added around the label for the derived clock signal 84 indicating that it was not acquired.

As described above with respect to FIG. 3, signals that are classified can be distinguished. Although an individual signal has been described as distinguished, other combinations of signals can be distinguished. A combined signal can be distinguished, a set of signals can be distinguished, or the like. For example, the derived clock signal 84 of FIG. 7 alone could be distinguished as in FIG. 3. Alternatively, the clock signal 80, the strobe signal 82, and the derived clock signal 84 of FIG. 7 can be distinguished similar to the illustration of FIG. 3. A user input can subsequently confirm the classification of the distinguished signals, regardless of which signals are distinguished.

FIG. 8 is a block diagram illustrating an example of a user interface annotating a setup and hold time according to an embodiment. In addition to establishing a clock definition, other sampling characteristics can be established through manipulation of the data view. For example, setup and hold times can be established.

Setup and hold times can be automatically set by a test and measurement instrument. However, in the event that they are not, if they are incorrect, if the user wants to change them, or the like, the setup and hold times can be established through the user interface 16.

Once a clock has been established, setup and hold times can be established for other signals relative to that clock. In this example, clock signal 90 has been established as a clock with the rising edge as a relevant timing edge. Data signal 94 is a signal for which an offset time, a setup time, and a hold time can be established. Offset time, in this instance, means the time difference between the acquired clock edge and the clock edge the user assumed during the design of the circuit. A user input, can establish a relationship between the clock signal 90 and the data signal 94. For example, a user can click on an edge of the clock signal 90 and drag a cursor to the data signal 94. In this example, a timing relationship 98 represents the offset between the clock signal 90 and the presumed location of the clock signal per the user's design. Timing relationship 96 represents the setup time and hold time of the data in relation to the user's presumed clock signal. Time T1 represents the offset time and times T2 and T3 represent the setup time and the hold time per the design characteristics of the user's circuit.

As described above, the test and measurement instrument may have automatically determined values for the offset, setup, and hold times, default values may have been established, or the like. Accordingly, the times T1, T2, and T3 can be initialized with those values in response to a user input. For example, the user input can associate a clock and a data signal. In response, the offset, setup, and hold times can be established from a default and presented to the user for manipulation.

In another embodiment, as described above, the times T1, T2, and T3 can be initialized with values according to the user input's relationship to the signals. For example, a first stroke from the edge 97 to the point 99 can establish the offset T1 based on the horizontal distance. Similarly, a second stroke from point 99 to point 101 can define the setup time T2, and a third stroke from 99 to 103 can define the hold time T3. In this example, the setup and hold times can be equal (T2=T3). As a result, the span of time T2+T3 is centered on point 99, where the offset time T1 ends.

The presentation of the times T1, T2 and T3, and the timing relationships 96 and 98 are only examples of potential annotations of an input signal. The annotation can take other forms. For example, the display 20 can include a time scale above the presented signals. Symbols, marks, or the like on the time scale can indicate particular times of interest relative to the input signals. A first mark can indicate the edge 97 of the clock signal 90. Second and third marks can indicate the boundaries of the setup and hold time. Any annotation, whether spatially located with the associated input signals or not, can be used.

Although a particular sequence of user inputs has been described to establish offset, setup, and hold times, any type of user input that creates a relationship between the clock signal 90 and the data signal 94 can be used. For example, a first tool can be selected to merely place an offset icon on the data signal 94. Handles on the offset icon can be moved to establish an offset between the data signal 94 and the clock signal 90, perhaps snapping to edges of the clock signal 90. A second user input can place a setup time and/or a hold time icon on the data signal 94 that can be similarly manipulated.

Regardless of the particular user input used, the user input can be in relation to the displayed signals. As a result, the user can establish timing information within a familiar environment, namely a timing diagram, without having to resort to dialog boxes, list views, or other similar abstractions outside of the context of the data.

Although the offset, setup, and hold times have been described as being input or modified through similar user inputs, such times can be input or modified through unrelated user inputs. For example, the offset can be established as described above. However, the setup time and hold time can be entered in a text box attached to the offset icon 98, clock signal 90 label, or the like.

Moreover, although the time T1 has been illustrated as extending forward in time relative to an edge 97 of the clock signal 90, the time T1 can also extend backward in time. Thus, the relative relationship of an edge of the clock signal 90 to the data signal 94 can be positive or negative.

In another embodiment, the relationship of the clock signal 90 and the data signal 94 itself can establish sampling characteristics. For example, once a clock has been defined, the horizontal relationship between the clock signal 90 and the data signal 94 can establish an offset time. A user input can move the data signal 94 relative to the clock signal 90 to adjust the offset time. Alternatively, the clock signal 90 can be moved in response to a user input to adjust the relationship. Any manipulation of the input signals having a relationship to time can be used for establishing an offset time.

An embodiment includes means for receiving user input indicating a data signal; and means for annotating the data signal in the presentation with a setup and hold time for the data signal. The means for receiving user input can include the user interface 16, described above. The means for annotating the data signal can include the processor 14, as described above.

FIG. 9 is a block diagram illustrating an example of applying a setup and hold time to other signals through a user interface according to an embodiment. Once sampling characteristics have been set up for a data signal, such as data signal 102, sampling characteristics for other data signals associated with the data signal can be established in response to the user input. In this embodiment, associated signals can include signals that would have similar offset times, setup and hold times, related to the same clock signal, related to similar clock signals, or the like. These associated data signals can, but need not have identical sampling characteristics. Moreover, the association of the data signals can, but need not have meaning within the context of a SUT. For example, two associated signals can be part of the same bus. In another example, two associated signals can be independent of one another, yet have similar setup and hold times.

For example, a user can select a tool, press a key to enter a meta-state, or the like to indicate a “rubber stamp.” Then the user input can indicate other signals such as data signals 104 and 106. The user inputs 110 and 112 associated with those data signals can result in the sampling characteristics for data signals 104 and 106 being set the same as data signal 102. As a result, a user can set up the sampling characteristics for a first signal, then those sampling characteristics can be copied to other signals as indicated by the user input. In this example, the user input can be selecting the data signals 104 and 106 with a particular tool. Again, the user can perform this configuration while in the context of the input signals.

In an embodiment, the sampling characteristics can be applied to all signals, all signals displayed in the data view, all signals that are in the same data bus grouping, or some other grouping of signals. This setting of sampling characteristics can be performed in response to a variety of user input, setup to be applied automatically, or the like. For example, the setting of the sampling characteristics can be in response to a user input manipulating a tool on the data view. In another example, once the sampling characteristics are created for one data signal, the sampling characteristics can be automatically applied to other data signals. Accordingly, sampling characteristics of a large number of signals can be established with a reduced number of user inputs, simplifying the configuration of the test and measurement instrument.

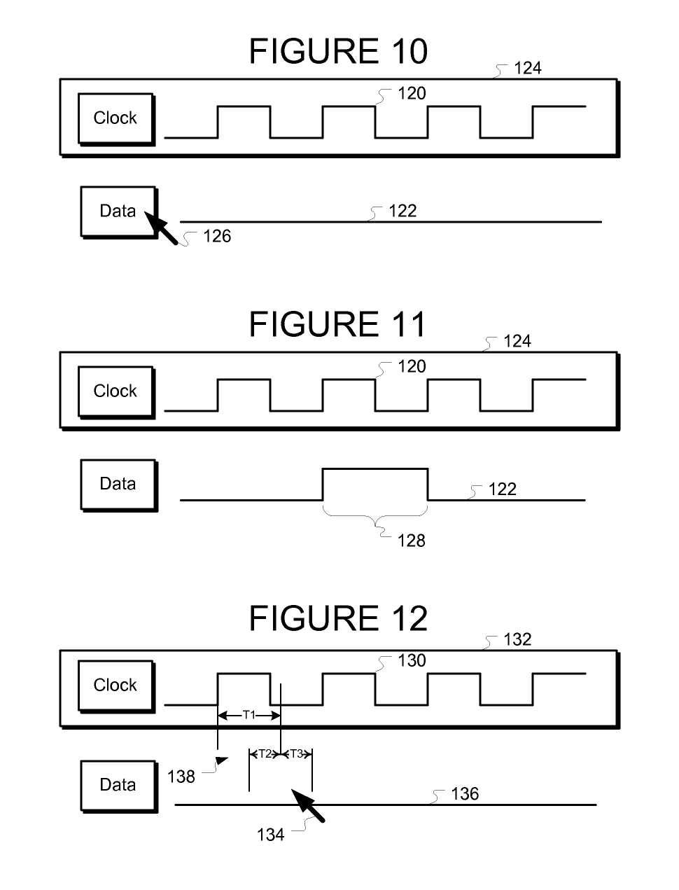

FIGS. 10 and 11 are block diagrams illustrating an example of a user interface presenting a transition in a signal according to an embodiment. When a data view is zoomed in sufficiently to see individual transitions of a clock signal, data signals displayed on the same scale may not have pulses, different levels, or other transitions within that view. As illustrated in FIG. 10, transitions of clock signal 120 are visible. However, no transitions are visible for data signal 122.

In response to user input 126, the data view can be adjusted until a transition in the data signal 122 appears. In one example, the timing for the data signal 122 alone can be changed so that a transition appears. In another example, the timing for the entire data view can be adjusted so that both the data signal 122 and the clock signal 120 shift in time until a transition in the data signal 122 appears in the data view.

FIG. 11 illustrates an example of a change to the user interface of FIG. 10. After the user input 126 was received, the pulse 128 of the data signal 122 can be presented to the user. For example, the processor 14 can search through the data signal 122 for a transition. Upon finding a transition, the processor 14 can update the display 20 to present the transition. In this example, a pulse 128 is presented, thereby presenting a transition. Accordingly, the user can use any of the above techniques to establish sampling characteristics for the data signal 122 in relation to actual transitions of the data signal 122, rather than in the abstract.

FIG. 12 is a block diagram illustrating an example of a user interface annotating a setup and hold time according to another embodiment. A data signal 136 may not have any changes that have been acquired. However, sampling characteristics can still be established. Accordingly, in response to the user input 134, a timing template 138 is applied to the data signal 136. As a result, a user can manipulate the timing template 138 as if there were transitions as described above. Even though the user does not have transitions of the data signal 136 to use as a guide for adjusting the sampling characteristics, the user can still manipulate those sampling characteristics in the context of the input signals. For example, the sampling characteristics can be manipulated using the clock signal 130, other data signals, or the like as a reference.

Although this technique has been described in relation to a data signal 136 that has no transitions within the acquired data, the used of a timing template is not limited to signals which have no changes within the acquired data. Accordingly, the timing template 138 can be applied to a signal regardless of whether the signal has changes or those changes are displayed.

In addition, the timing template 138 was illustrated similar to the timing relationships 96 and 98 of FIG. 8 merely as an example. The timing template can take other forms. Moreover, the form of the timing template need not be similar to other techniques for establishing sampling characteristics. For example, one form can be used when operating as described with reference to FIG. 8 on a data signal with acquired transitions. A second form can be used when using the timing template as described with reference to FIG. 12 on a data signal without transitions.

When presented with a user interface as described above, a user can create sampling characteristics for a test and measurement instrument while the user's concentration, conceptual train of thought, and the like remain focused on the data. Consider an example of setting up a test and measurement instrument using some of the above examples. Referring to FIG. 1, input signals 10 are asynchronously acquired by the acquisition system 12. The processor 14 presents those signals to the user through the user interface 16. Namely, the signals are presented to the user through the display 16.

Assume that the test and measurement instrument identified one of the signals as a clock signal. Accordingly, the processor 14 can present that signal as distinguished from other signals as illustrated in FIG. 3. Through a pointing device 22, the user can click on the clock signal to provide the user input 44 as illustrated in FIG. 4. The user can then click on an edge such as edge 75 of FIG. 6. In response to these user inputs, the processor 14 can establish the clock signal for a subsequent synchronous acquisition using the selected edge.

Having established a clock definition, the user can proceed to establish sampling characteristics for the other acquired signals. The user can click on edge 97 of FIG. 8 and drag a pointer to point 99 on the data signal 94. As a result, time T 1 is established. A user can then click on point 101 to establish the time T2 for the setup time and then click on point 103 to establish the time T3 for the hold time.

Having established sampling characteristics for data signal 94, a user can then establish sampling characteristics for other data signals. As illustrated in FIG. 9, assuming that sampling characteristics for data signal 102 has been established, a user can select data signals 104 and 106 with user inputs 110 and 112. The user inputs 110 and 112 can be selections using a “rubber stamp” tool as described above.

As a result, sampling information, such as a clock or clocks used to synchronously sample input signals and setup and hold times for input signals, can be established through manipulation of and within the context of the presentation of the input signals. The user can manipulate the signals within the user interface rather than breaking the user's concentration, for example, by presenting a user with a dialog box outside of the context of the input signals.

Another embodiment includes an article of machine readable code embodied on a machine readable medium that when executed, causes the machine to perform any of the above described operations. An embodiment includes a machine readable storage medium storing machine readable code that when executed causes the machine to perform any of the above described operations. As used here, a machine is any device that can execute code. Microprocessors, programmable logic devices, multiprocessor systems, digital signal processors, personal computers, or the like are all examples of such a machine.

In an embodiment, the test and measurement instrument is a hardware device. In another embodiment, the test and measurement instrument is a software application. Another embodiment includes a combination of hardware and software. A test and measurement instrument can be implemented by any combination of such hardware and software processing.

Although particular embodiments have been described, it will be appreciated that the principles of the invention are not limited to those embodiments. Variations and modifications may be made without departing from the principles of the invention as set forth in the following claims.

1. A test and measurement instrument, comprising:
an acquisition system configured to acquire a plurality of input signals;
a processor coupled to the acquisition system; and
a user interface coupled to the processor, the user interface configured to receive user input;
wherein the processor is configured to:
present the input signals through the user interface; and
define a sampling characteristic of the test and measurement instrument in response to the user input manipulating the presented input signals.

2. The test and measurement instrument of claim 1, wherein:
the acquisition system is further configured to asynchronously acquire the input signals and synchronously acquire a subsequent acquisition in response to the sampling characteristic.

3. The test and measurement instrument of claim 1, wherein the processor is further configured to:
distinguish at least one of the presented input signals based on a classification of the input signal through the user interface; and
confirm the classification of the distinguished signal in response to the user input.

4. The test and measurement instrument of claim 3, wherein the processor is further configured to confirm the classification of the distinguished signal as at least one of a clock, a strobe, and data in response to the user input.

5. The test and measurement instrument of claim 3, wherein the processor is further configured to further distinguish the distinguished signal through the user interface in response to confirmation of the classification of the distinguished signal.

6. The test and measurement instrument of claim 3, wherein the processor is further configured to adjust the classification of the input signal in response to the user input.

7. The test and measurement instrument of claim 1, wherein the processor is further configured to annotate a data signal of the input signals through the user interface with at least one of an offset time, a setup time and a hold time for the data signal.

8. The test and measurement instrument of claim 7, wherein the processor is further configured to change the at least one of the offset time, the setup time and the hold time in response to the user input.

9. The test and measurement instrument of claim 7, wherein the processor is further configured to set at least one of an offset time, a setup time and a hold time for another signal of the input signals based on the at least one of the offset time, the setup time and the hold time for the data signal in response to the user input.

10. The test and measurement instrument of claim 1, wherein:
the user input indicates a first input signal and a second input signal; and
the processor is further configured to set an offset between the first input signal and the second input signal in response to the user input.

11. The test and measurement instrument of claim 1, wherein the processor is further configured to change the presentation of a data signal to present a transition of the data signal through the user interface.

12. The test and measurement instrument of claim 11, wherein the processor is further configured to annotate the presented change in the data signal with at least one of a setup time and a hold time for the data signal in response to the user input.

13. The test and measurement instrument of claim 1, wherein:
the user input indicates a timing template associated with a data signal; and
the processor is further configured to establish timing information for the data signal in response to the timing template user input.

14. The test and measurement instrument of claim 1, wherein the processor is further configured to establish operating conditions for the acquisition system in response to the confirmed classification.

15. A method of configuring a test and measurement instrument, comprising:
presenting acquired data, the acquired data including a plurality of signals;
receiving a user input; and
defining a sampling characteristic of the test and measurement instrument in response to the user input manipulating the presented acquired data.

16. The method of claim 15, further comprising:
distinguishing at least one of the signals based on a classification of the signal; and
confirming the classification of the signal in response to a user input.

17. The method of claim 15, further comprising confirming the classification of the signal as at least one of a clock, a strobe, and data in response to the user input.

18. The method of claim 15, further comprising:
receiving a second user input indicating a data signal; and
annotating the data signal in the presentation with at least one of a setup time and a hold time for the data signal.

19. The method of claim 15, further comprising:
receiving a second user input indicating a data signal; and
adjusting a relative position of the data signal and an associated clock signal in response to the second user input; and
establishing an offset time for the data signal in response to the relative position.

20. The method of claim 15, further comprising:
establishing operating conditions for the acquisition system in response to the confirmed classification.

21. A test and measurement instrument, comprising:
means for asynchronously acquiring a plurality of input signals;
means for presenting the input signals and distinguishing at least one of the input signals based on a classification of the input signal; and
means for receiving user input confirming the classification of the input signal.

22. The test and measurement instrument of claim 21, further comprising means for receiving user input confirming the classification of the input signal as at least one of a clock, a strobe, and data.

23. The test and measurement instrument of claim 21, further comprising:
means for receiving user input indicating a data signal; and
means for annotating the data signal in the presentation with at least one of an offset time, a setup time, and a hold time for the data signal.

24. The test and measurement instrument of claim 21, further comprising means for establishing operating conditions for the acquisition system in response to the confirmed classification.
